(19) United States
(12) Patent Application Publication
(10) Pub. No.: US 2018/0119304 A1
(43) Pub. Date: May 3, 2018

(54) PARTIAL PLATING METHOD FOR RESIN PART OF VEHICLE AND PLATED RESIN PART OF VEHICLE USING THE SAME

(71) Applicants: HYUNDAI MOTOR COMPANY, Seoul (KR); KIA MOTORS CORPORATION, Seoul (KR); SAMSHIN CHEMICAL CO., LTD., Ansan-si (KR)

(72) Inventors: Hyun-Gyung KIM, Hwaseong-si (KR); Dong-Eun CHA, Seongnam-si (KR); Jin-Young Yoon, Gimpo-si (KR); Woo-Taik OH, Ansan-si (KR)

(73) Assignees: HYUNDAI MOTOR COMPANY, Seoul (KR); KIA MOTORS CORPORATION, Seoul (KR); SAMSHIN CHEMICAL CO., LTD., Ansan-si (KR)

(21) Appl. No.: 15/377,799

(22) Filed: Dec. 13, 2016

(30) Foreign Application Priority Data
Oct. 31, 2016 (KR) 10-2016-0143523

(51) Int. Cl. C25D 5/54; B05D 1/32; C25D 5/02; C25D 5/34; B60R 19/52

(52) U.S. Cl. CPC C25D 5/54; B05D 1/32; C25D 5/022; B60Y 2410/122; B60R 19/52; B60R 2019/525; B60Y 2304/03; C25D 5/34

(57) ABSTRACT

A partial plating method for a resin part of a vehicle may include a masking step of applying masking paint on an injection molded product made of a plastic resin to divide the injection molded product into a plating area on which a metal component is to be plated and a non-plating area on which the metal component is not to be plated, an etching step of etching the masked injection molded product in an etching solution to elute some components of the resin from the plating area, and an electroplating step of electroplating the etched injection molded product in a plating bath.

### CROSS-REFERENCE TO RELATED APPLICATIONS

This application claims priority to Korean Patent Application No. 10-2016-0143523, filed on Oct. 31, 2016, which is incorporated herein by reference in its entirety.

### BACKGROUND

### Field

The present disclosure relates to partially plating a vehicle part.

### Description of Related Art

In accordance with development of a plastic technology capable of exhibiting excellent strength, heat resistance, and thermal conductivity comparable to metal, use of plastics as a lightweight material for improving fuel efficiency in exterior parts of a vehicle has been increased.

Particularly, as consumer's requirements for exterior parts of a vehicle are gradually diversified and differentiation of design and function proceeds for each vehicle manufacturers, importance of a plastic surface treatment technology for improving appearance of plastic components to diversify product designs and improve quality and securing durability such as weather resistance, heat resistance, water resistance, or the like to prolong lifespan of automobile parts and improve safety, is being emphasized.

According to one of the plastic surface treatment technologies, an exterior part made of the plastic material may be plated with a metal component to thereby form a metallic appearance while securing lightness of the plastic material.

However, the technology of plating an outer surface of the plastic material with a metal component according to the related art has a problem in that a large amount of metal component is required for plating since the metal component is plated on the entire surface of the exterior part made of the plastic material.

The disclosure of this section is to provide background of the invention. Applicant notes that this section may contain information available before this application. However, by providing this section, Applicant does not admit that any information contained in this section constitutes prior art.

### SUMMARY

An embodiment of the present invention is directed to a partial plating method for a resin part of a vehicle in which a portion of a plastic exterior part of the vehicle is masked so as to divide the plastic exterior part into a plating area and a non-plating area, and wet electroplating is performed such that only the plating area is plated with a metal component, and a plated resin part of a vehicle using the same.

Other features and advantages of the present invention can be understood by the following description, and become apparent with reference to the embodiments of the present invention. Also, it is obvious to those skilled in the art to which the present invention pertains that the features and advantages of the present invention can be realized by the means as claimed and combinations thereof.

In accordance with an embodiment of the present invention, a partial plating method for a resin part of a vehicle includes: a masking step of applying masking paint on an injection molded product made of a plastic resin to divide the injection molded product into a plating area on which a metal component is to be plated and a non-plating area on which the metal component is not to be plated, an etching step of etching the masked injection molded product in an etching solution to elute some components of the resin from the plating area, and an electroplating step of electroplating the etched injection molded product in a plating bath.

In the masking step, the masking paint containing a polymer resin composition may be applied along a circumference of the non-plating area.

The masking paint may be applied in a closed curve shape.

The masking paint may be a polyvinyl chloride (PVC) paint.

The masking paint may be a mixture of poly vinyl chloride (PVC) and an ethylene-vinyl acetate copolymer (EVA).

At least two electrodes may be installed in the plating area of the injection molded product.

In the masking step, a portion of a front surface of the injection molded product that is exposed to the outside may be set as the plating area.

In the masking step, a circumference of the plating area in the front surface of the injection molded product and a rear surface of the injection molded product may be set as the non-plating area.

In the masking step, the non-plating area may include a portion on which the masking paint is applied.

In accordance with another embodiment of the present invention, a plated resin part of a vehicle by using a partial plating method for a resin part of a vehicle that is manufactured by electroplating with a metal component an injection molded product made of a plastic resin and attached on an outer portion of the vehicle, is manufactured by applying masking paint on the injection molded product to divide the injection molded product into a plating area on which the metal component is plated and a non-plating area on which the metal component is not plated, etching the masked injection molded product, and then electroplating the etched injection molded product in a plating bath in which the metal component is dissolved.

The masking paint may be applied in a closed curve shape along a circumference of the non-plating area.

The masking paint may be a mixture of poly vinyl chloride (PVC) and an ethylene-vinyl acetate copolymer (EVA).

The resin part for a vehicle may be a radiator grille.

### BRIEF DESCRIPTION OF THE DRAWINGS

FIG. 1 is a perspective view illustrating a radiator grille in a semi-product (intermediate product) state before partially plating in accordance with an embodiment of the present invention is used.

FIG. 2 is a cross-sectional view taken along line A-A of FIG. 1 and illustrating a state in which a resin part is divided into a plating area and a non-plating area by masking paint in accordance with an embodiment of the present invention.

FIG. 3 is a perspective view illustrating a radiator grille after the partial plating in accordance with an embodiment of the present invention.

FIG. 4 is a cross-sectional view taken along the line A-A of FIG. 3.

FIG. 5 is a flow chart illustrating the partial plating method for a resin part of a vehicle in accordance with an embodiment of the present invention.

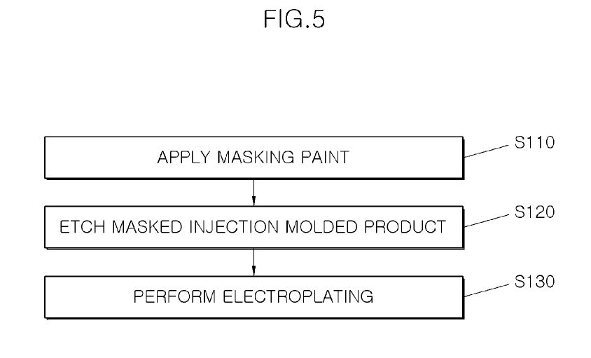

### DESCRIPTION OF EMBODIMENTS

Hereinafter, a partial plating method for a resin part of a vehicle in accordance with embodiments of the present invention will be described in detail with reference to the accompanying drawings.

A partial plating method for a resin part of a vehicle in accordance with embodiments of the present invention includes a masking step (S110) of applying masking paint 13 on an injection molded product made of a plastic resin to divide the injection molded product into a plating area 11 on which a metal component is to be plated and a non-plating area 12 on which the metal component is not to be plated, an etching step (S120) of etching the masked injection molded product in an etching solution to elute some components of the resin from the plating area, and an electroplating step (S130) of electroplating the etched injection molded product in a plating bath.

In the masking step (S110), the plastic injection molded product made by the injection molding is divided into the plating area 11 on which the metal component is to be plated and the non-plating area 12 on which the metal component is not to be plated, using the masking paint.

Only a portion of the injection molded product that is exposed to the outside is plated with the metal component, and a portion that is not exposed to the outside is not plated with the metal component, the injection molded product being an exterior part of a vehicle. Therefore, the portion that is exposed to the outside becomes the plating area 11, and the portion that is not exposed to the outside becomes the non-plating area 12.

An example of the injection molded product may include a radiator grille 10 installed on a front surface of the vehicle. The radiator grille 10 serves to protect a radiator installed in an engine room of the vehicle, and also is a main element for forming a front surface design of the vehicle. Generally, the radiator grille 10 is made of a plastic resin, but some high-class vehicles are made of metal material, or made by plating the plastic resin with a metal component.

In accordance with embodiments of the present invention, in a process of plating the plastic resin with the metal component, only a portion is plated with the metal component, thereby decreasing an area on which the metal material is plated while sufficiently implementing a metallic appearance.

In the masking step (S110), the masking paint is applied along a circumference of the non-plating area 12. Since the masking paint is applied along the circumference of the non-plating area, the masking paint is applied in a closed curve shape. The masking paint is applied in the closed curve shape, thus the portion on which the masking paint is applied and an inner portion of the closed curve are the non-plating area 12.

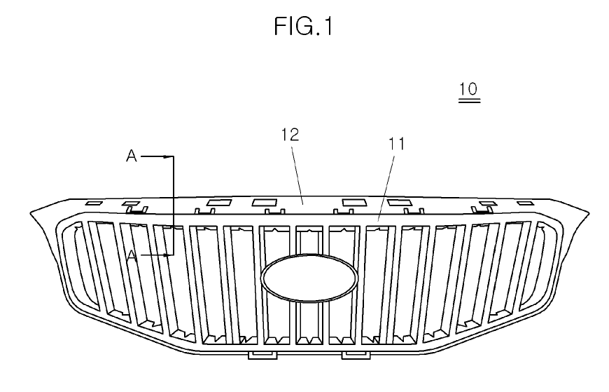

FIG. 1 illustrates the radiator grille 10 in a semi-product (intermediate product) state. A front surface of the radiator grille is the plating area 11 that is exposed to the outside, and the rest portion including a circumference of the front surface is the non-plating area 12. Further, an entire rear surface of the radiator grille 10 is the non-plating area 12.

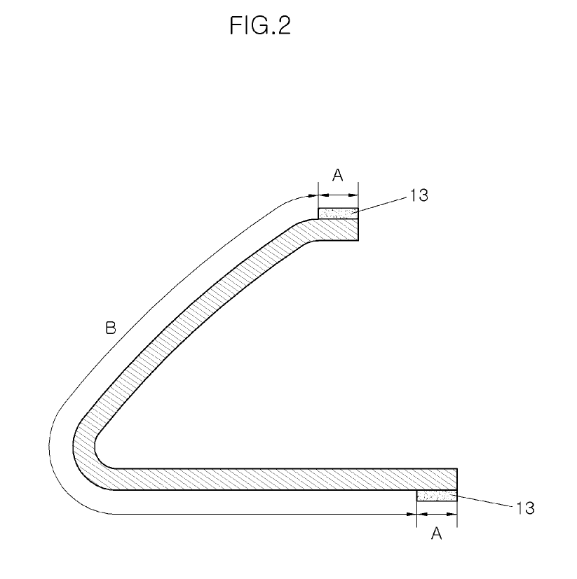

That is, as illustrated in FIG. 2, in the radiator grille 10, the masking paint 13 is applied along the circumference of the front surface of the radiator grille 10, thus a section A in the front surface and the entire rear surface are the non-plating area 12, and a section B in the front surface that is exposed to the outside is the plating area 11.

In the masking step (S110), the masking paint 13 used for masking contains a polymer resin composition. For example, the masking paint 13 may be poly vinyl chloride (PVC) or a mixture of the PVC paint and an ethylene-vinyl acetate copolymer (EVA) paint.

In the etching step (S120), the injection molded product is etched in the etching solution. Through the etching step (S120), some components are eluted from the injection molded product.

Some components of the resin are eluted from the injection molded product, such that the metal component infiltrates into the portion from which some components are eluted at the time of plating. As a result, a binding force between the metal component plated on a surface of the plating area 11 and the injection molded product is improved.

Meanwhile, in the etching step S120, in the portion applied with the masking paint, there is no component eluted from the injection molded product due to the masking paint 13, and since the masking paint 13 is applied, the metal component is not plated thereon, thus the portion applied with the masking paint becomes the non-plating area. Further, a portion surrounded by the masking paint 13 also becomes the non-plating area since the metal component is not plated thereon at the time of electroplating to be described below.

For example, when the injection molded product is made of an acrylonitrile-butadiene-styrene (ABS) resin, the masking paint 13 serves to prevent elution of butadiene from the ABS resin in the etching step (S120). In the plating area 11, since butadiene is eluted from the ABS resin to the outside through the etching, the metal component infiltrates into the eluted portion, thereby increasing the binding force of the metal component applied on the plating area 11.

In the electroplating step (S130), the etched injection molded product is plated with the metal component in the plating bath in which the metal component is dissolved.

In the electroplating step (S130), a current is applied through an electrode installed in the injection molded product, such that the metal component dissolved in the plating bath is plated on the surface of the injection molded product.

Particularly, in the electroplating step (S130), the metal component is not plated on the non-plating area formed by dividing the injection molded product by the masking paint 13. In the injection molded product, at least two electrodes for electroplating are installed along the circumference of the plating area 11, and when the current is applied to the electrode, the current flows through the inside of the plating area 11. The masking paint 13 serves as an insulating material, thus the portion on which the masking paint 13 is applied and an inner portion thereof are not plated with the metal component.

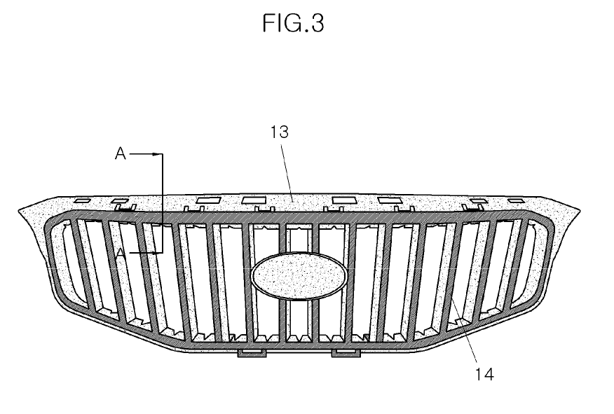

Accordingly, after the etched injection molded product is electroplated, the injection molded product has a completed shape as illustrated in FIG. 3. A portion in the radiator grille 10 that is hatched with diagonal lines is a metal plating layer formed on the plastic resin through the electroplating.

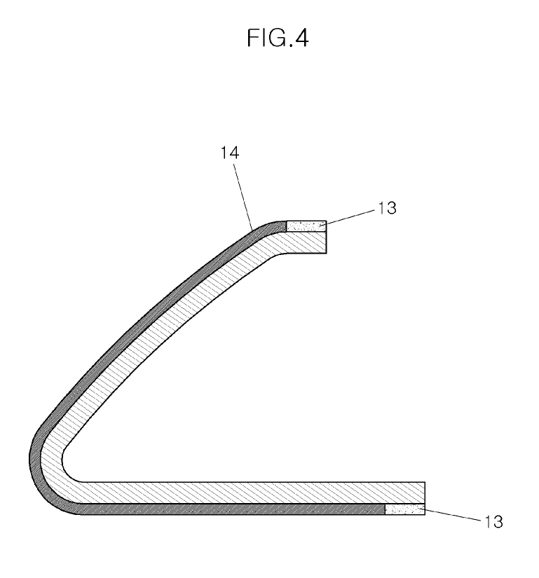

FIG. 4 is a cross-sectional view illustrating that a uniform metal plating layer 14 is formed only on the portion that is set as the plating area 11 in the masking step (S110). The metal plating layer 14 is not formed on the rest portions, that is, the portion on which the masking paint 13 is applied and the rear surface of the injection molded product.

The metal plating layer 14 is formed only on the plating area 11 that is an area exposed to the outside, thereby reducing the plated area.

A plated resin part of a vehicle by using the partial plating method for a resin part of a vehicle in accordance with embodiments of the present invention is manufactured by using the partial plating method for a resin part of a vehicle as described above.

The resin part of a vehicle to be used in the vehicle is manufactured in a semi-product (intermediate product) state by injection molding using the plastic resin, and then becomes a partially plated complete product by using the above-described partial plating method in which only the portion exposed to the outside is plated with the metal component.

Here, an example of the resin part of a vehicle may include the radiator grille 10 installed on the front surface of the vehicle.

The portion in the radiator grille 10 that is exposed to the outside, that is, the front surface is plated with the metal component to have an improved appearance, and the circumference of the front surface and the rear surface that are not exposed to the outside are not plated with the metal component, thereby decreasing the plated area.

Since the area plated with the metal component is decreased, a use amount of expensive metal component is decreased as much as the decreased area, thereby making it possible to reduce costs.

In embodiments, an intermediate product made of a plastic or resin material is provided for partial plating. In embodiments, the intermediate product is produced by an injection molding. In embodiments, the intermediate product includes at least one surface for metal plating and at least one additional surface for no metal plating. In embodiments, the at least one surface for plating may be or may not be discrete from the at least one additional surface for no plating. In embodiments, the intermediate plastic product includes a first surface for plating and a second surface for no plating that is immediately next the first surface such that the first surface abuts the second plating surface. In the embodiments, the first and second abutting surfaces are made of the same resin material, although not necessary. In some embodiments, the first and second abutting surfaces include an acrylonitrile-butadiene-styrene (ABS) resin material.

In embodiments, the intermediate product is partially applied with a masking material or masking paint to separate the surface for plating from the abutting surfaces for no plating. In the intermediate product including the first surface for plating and the second surface for no plating, the masking material is applied over the second surface along the edge of the second surface such that the first surface for plating is not covered by the masking material while the masking material overlays or covers the second surface or a band along the edge. In embodiments, the first surface for plating is exposed while the second surface is at least partially covered to define the outer boundary of the first surface. In embodiments, the masking material is applied along the boundary of the first surface for plating such that the masking material forms a closed loop surrounding the first surface.

In embodiments, the first surface for plating of the partially-masked intermediate product is subject to etching by contacting the first surface to a liquid etchant. In embodiments, at least one component of the resin material from the exposed first surface is eluted or dissolved by the etchant. In embodiments, the masking material blocks the etchant from contacting the second surface or the band portion of the second surface that is covered by the masking material. In embodiments, when the first surface includes an ABA resin material, butadiene is eluted from the first surface for plating.

In embodiments, the etched intermediate product is subject to metal plating to form a metallic layer on the first surface. In embodiments, one or more electrodes are formed on the first surface for plating, e.g., along the boundary of the first surface surrounded by the masking material. In embodiments, the intermediate product is placed in a plating bath such that the first surface and the one or more electrodes contact a plating liquid contained in the plating bath. Subsequently, in embodiments, electric current is applied for electroplating onto the first surface to form a metallic layer surrounded by the masking material. Subsequently, the masking material is removed. In embodiments, the resulting product includes the metallic plated layer on the first surface while not extending the second surface for no plating.

According to the partial plating method for a resin part of a vehicle and the plated resin part of a vehicle by using the same with the configuration described above in accordance with embodiments of the present invention, by performing masking so as to divide the resin part into the plating area and the non-plating area, and performing plating with the metal component so that only the portion of the exterior part of the vehicle that is exposed to the outside is plated with the metal component, it is possible to reduce the plating area.

As the plating area is reduced, the amount of metal component required for plating is decreased, thus it is possible to reduce cost and weight of the exterior parts.

What is claimed is:

1. A partial plating method for a resin part of a vehicle, comprising: a masking step of applying masking paint on an injection molded product made of a plastic resin to divide the injection molded product into a plating area on which a metal component is to be plated and a non-plating area on which the metal component is not to be plated, an etching step of etching the masked injection molded product in an etching solution to elute some components of the resin from the plating area, and an electroplating step of electroplating the etched injection molded product in a plating bath.

2. The partial plating method of claim 1, wherein in the masking step, the masking paint containing a polymer resin composition is applied along a circumference of the non-plating area.

3. The partial plating method of claim 2, wherein the masking paint is applied in a closed curve shape.

4. The partial plating method of claim 2, wherein the masking paint is a poly vinyl chloride (PVC) paint.

5. The partial plating method of claim 4, wherein the masking paint is a mixture of poly vinyl chloride (PVC) and an ethylene-vinyl acetate copolymer (EVA).

6. The partial plating method of claim 1, wherein at least two electrodes are installed in the plating area of the injection molded product.

7. The partial plating method of claim 1, wherein in the masking step, a portion of a front surface of the injection molded product that is exposed to the outside is set as the plating area.

8. The partial plating method of claim 7, wherein in the masking step, a circumference of the plating area in the front surface of the injection molded product and a rear surface of the injection molded product are set as the non-plating area.

9. The partial plating method of claim 8, wherein in the masking step, the non-plating area includes a portion on which the masking paint is applied.

10. A plated resin part of a vehicle that is manufactured by electroplating with a metal component an injection molded product made of a plastic resin and attached on an outer portion of the vehicle, wherein it is manufactured by applying masking paint on the injection molded product to divide the injection molded product into a plating area on which the metal component is plated and a non-plating area on which the metal component is not plated, etching the masked injection molded product, and then electroplating the etched injection molded product in a plating bath in which the metal component is dissolved.

11. The plated resin part of claim 10, wherein the masking paint is applied in a closed curve shape along a circumference of the non-plating area.

12. The plated resin part of claim 10, wherein the masking paint is a mixture of poly vinyl chloride (PVC) and an ethylene-vinyl acetate copolymer (EVA).

13. The plated resin part of claim 10, wherein the resin part for a vehicle is a radiator grille.
